(19) United States
(12) Patent Application Publication
(10) Pub. No.: US 2026/0089441 A1
(43) Pub. Date: Mar. 26, 2026

(54) Warped Filter Architecture with Reduced Processing Rate Systems and Methods

(71) Applicant: Apple Inc., Cupertino, CA (US)

(72) Inventors: Dana C Massie, Santa Cruz, CA (US); Aniruddha Satoskar, Round Rock, TX (US); Brendan C Larks, San Diego, CA (US); Brian D Clark, San Jose, CA (US); Hanchi Chen, Mountain View, CA (US); Leonardo Rub, Sunnyvale, CA (US); Peter C Eastty, San Francisco, CA (US)

(21) Appl. No.: 19/002,437

(22) Filed: Dec. 26, 2024

Related U.S. Application Data
(60) Provisional application No. 63/699,701, filed on Sep. 26, 2024.

(51) Int. Cl. H04R 3/04; G10K 11/178; H04R 1/10; H04R 3/00

(52) U.S. Cl. CPC H04R 3/04; G10K 11/17854; H04R 3/002; H04R 1/1083

(57) ABSTRACT

An electronic device may include a microphone that receives a first acoustic sound and generates a first audio signal based on the first acoustic sound. The electronic device may also include filter circuitry having multiple filter stages, each filter stage including an all-pass filter and a multiplier where respective outputs of each of the filter stages are summed in series. Moreover, the filter circuitry may determine a filter input based on the first audio signal and process the filter input via the filter stages to generate a second audio signal. The electronic device may also include a speaker to output a second acoustic sound based on the second audio signal.

### CROSS-REFERENCE TO RELATED APPLICATIONS

This application claims priority to U.S. Provisional Application No. 63/699,701, filed Sep. 26, 2024, which is incorporated by reference herein in its entirety.

### BACKGROUND

The present disclosure relates generally to digital data filters and, more specifically, filter architectures that improve operational efficiency such as reduced power consumption and/or reduced latency.

In general, electronic devices utilize filters, such as finite impulse response (FIR) filters, to shape or modify signals such as audio, video, and/or communication signals. Indeed, filters may be implemented digitally, such as to operate on a digital signal, and/or via analog circuitry for operating on analog signals. Furthermore, filters are used for a number of reasons such as improving the clarity of the signal being modified, adding functionality to the electronic device by performing an augmentation to the signal, and/or performing statistical analysis of the signal being filtered, to name a few. However, filters may incur operating costs such as power consumption and/or introduce latency in the signal being filtered.

In some scenarios, the operating costs associated with filtering may be prohibitive and/or reduce the efficacy of the electronic device. For example, audio signals may be filtered to augment an audio output of an electronic device for improved sound quality and/or to implement features such as noise canceling. However, the implementation of filters to this end may cause undesired power draws, which may reduce a battery life of the electronic device. Moreover, timing constraints, such as associated with noise canceling features, may limit the usage, type, and/or quality of a filter's utilization and/or cause the filter to operate at an increased frequency, which may increase power consumption.

### SUMMARY

This disclosure is generally directed to digital data filters and, more specifically, filter architectures that improve operational efficiency such as reduced power consumption and/or reduced latency. In general, electronic devices utilize filters to shape or modify signals such as audio, video, and/or communication signals. However, filters may incur operating costs such as power consumption and/or introduce latency in the signal being filtered. For example, an electronic device or system may perform noise canceling by receiving (e.g., via a microphone) ambient audio sounds, performing filtering of the ambient audio sounds, and output (e.g., via a speaker) a counteracting audio sound that, when synchronized with the ambient audio sounds at a listening location (e.g., human car), the ambient audio sounds are reduced or inaudible. However, timing the output of the counteracting audio sound to match the ambient audio sounds may constrain the timing available for filtering the ambient audio sounds and generating the counteracting audio sound. Furthermore, in some scenarios, tradeoffs may occur between quality of the filtering, the latency of the filter, and/or the power consumption of the filter. As such, embodiments of the present disclosure include filter circuitry utilizing a warped finite impulse response filter (FIR) with an improved architecture and/or signal modulation to reduce power consumption while maintaining or improving quality and maintaining or improving (e.g., reducing) latency.

In some embodiments, the filter circuitry may sample an input signal (e.g., corresponding to a captured audio signal) at an input sampling rate and include a warped FIR filter block that performs filtering through a set of filtering stages (e.g., to generate a counteracting audio signal for noise cancelation). The filter circuitry may also include a sample-rate conversion block to reduce the input sampling rate and increase the bit-depth of the input signal and include a noise shaped quantizer block that performs noise shaping, in accordance with an oversampling rate of the input signal, such as for improving the signal-to-quantization-noise ratio (SQNR) in frequency bands of interest (e.g., an audio range typically sensitive to humans). Furthermore, the noise shaped quantizer block of the filter circuitry may utilize a higher order (e.g., higher than first order) modulation technique and/or higher bit quantizer to perform noise shaping while maintaining a sampling rate less than the input sampling rate. As such, the fidelity of the input signal, particularly in a noise shaped frequency band of interest, may be maintained while the processing rate is decreased (e.g., relative to the input sampling rate) to the filter input sampling rate.

In some embodiments, the filtering stages of the warped FIR block may include a series of all-pass filter stages that provide phase shifts to a filter input thereof (e.g., the filter input). Additionally, the warped FIR filter may include a number of multipliers in parallel that operate to weight different phase responses of the filter input. By defining the coefficients of the multipliers and all-pass filters, the filter input may be modified to achieve a desired result, such as a counteracting audio signal corresponding to ambient noise represented by the input signal. Additionally, the warped FIR block may allow for a non-uniform frequency resolution that focuses on a frequency range of interest (e.g., similar to the modulation), which may utilize fewer tap points than a traditional FIR filter to maintain the resolution in the frequency range of interest.

Additionally, in some embodiments, the coefficients of the warped FIR filter may be dynamically adaptive. This may allow corrections or changes to the effect of the warped FIR filter on the filter input. For example, in the case of noise cancelation, while a first microphone receives ambient noise, a second microphone may be implemented at the output (e.g., speaker location) of the electronic device to receive a combined audio including the ambient noise and the counteracting audio. A dynamic adaptive block of the filter circuitry may determine an error associated with the phase, frequencies, and/or amplitudes of the counteracting audio and adjust the coefficients of the warped FIR filter based thereon to synchronize the ambient noise and the counteracting audio for improved cancelation. As such, filter circuitry, including a warped FIR filter, may be utilized for digital signal processing of an input signal with increased or maintained signal quality (e.g., in a frequency band of interest), decreased or maintained latency, and/or decreased energy consumption (e.g., power savings).

### BRIEF DESCRIPTION OF THE DRAWINGS

Various aspects of this disclosure may be better understood upon reading the following detailed description and upon reference to the drawings in which:

FIG. 1 is a block diagram of an electronic device including filter circuitry, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIG. 6 is a perspective view of an audio device representing an example of the electronic device of FIG. 1, according to embodiments of the present disclosure;

FIG. 7 is a perspective view of a headset representing an example of the electronic device of FIG. 1, according to embodiments of the present disclosure;

FIG. 8 is a block diagram of filter circuitry of FIG. 1, including a warped FIR filter block, a sample-rate conversion block, a noise shaped quantizer block, and a dynamic adaptation block, according to embodiments of the present disclosure;

FIG. 9 is a schematic diagram of a digital signal processing (DSP) path of the electronic device of FIG. 1 relative to an acoustic path of an environmental audio sound, according to embodiments of the present disclosure;

FIG. 10 is a schematic diagram of a finite impulse response (FIR) filter having a filter input, multiple filter stages, and a filtered signal as an output, according to embodiments of the present disclosure;

FIG. 11 is a schematic diagram of a portion of the filter circuitry of FIGS. 1 and 8 including a warped FIR filter having a filter input, multiple filter stages, and a filtered signal as an output, according to embodiments of the present disclosure; and

FIG. 12 is a flowchart of an example process for implementing filter circuitry to generate a dynamically adaptive audio output based on a received audio input, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

In general, electronic devices utilize filters, such as finite impulse response (FIR) filters, to shape or modify signals such as audio, video, and/or communication signals. Indeed, filters may be implemented digitally, such as to operate on a digital signal, and/or via analog circuitry for operating on analog signals. Furthermore, filters are used for a number of reasons, such as improving the clarity of the signal being modified, adding functionality to the electronic device by performing an augmentation to the signal, and/or performing statistical analysis of the signal being filtered, to name a few. However, filters may incur operating costs such as power consumption and/or introduce latency in the signal being filtered. Moreover, in some scenarios, tradeoffs may occur between quality of the filter (e.g., effectiveness for the desired purpose), the latency of the filter, and/or the power consumption of the filter. For example, if a reduced power consumption is desired, the quality may decrease and/or the latency may increase, and if a reduced latency is desired, the power consumption may increase and/or quality may decrease. As should be appreciated, decreased power consumption may be of particular advantage in mobile devices, such as to increase a battery life of the electronic device. Moreover, a reduction in quality and/or an increase in latency may be undesirable or unacceptable, depending on the implementation. As such, embodiments of the present disclosure include a warped finite impulse response filter (FIR) with an improved architecture that reduces power consumption while maintaining or improving quality and maintaining or improving latency.

As should be appreciated, the techniques discussed herein may be applicable in any suitable electronic device for use on any suitable digital data, such as audio data, image data, communications data, etc. For example, audio signals may be filtered to augment an audio output of an electronic device for improved sound quality and/or to implement features such as noise canceling. In some embodiments, timing constraints may be implemented to ensure proper functionality. For example, an electronic device or system may perform noise canceling by receiving (e.g., via a microphone) ambient audio sounds, performing filtering of the ambient audio sounds, and outputting (e.g., via a speaker) a counteracting audio sound that, when synchronized with the ambient audio sounds at a listening location (e.g., human car), the ambient audio sounds are reduced or inaudible. However, timing the output of the counteracting audio sound to match the ambient audio sounds may constrain the timing available for filtering the ambient audio sounds and generating the counteracting audio sound. Traditionally, analog circuitry has been utilized to in such scenarios where latency is of considerable interest. However, analog circuitry may be particularly power intensive and/or provide no or reduced dynamic feedback. Furthermore, typical digital filters may be associated with increased latency that may be unacceptable in certain scenarios. As such, in accordance with aspects of the present disclosure, a warped FIR filter may be utilized to implement an improved filter architecture that maintains a filtering quality for a given time constraint (e.g., latency) with reduced power consumption.

In general, an input signal (e.g., such as from a microphone) may be sampled at an input sampling rate and have an input bit-depth. For example, environmental audio sounds may be captured via a microphone and the output thereof sampled at the sampling rate, such as 3.072 megahertz (MHz), with a bit-depth of 1-bit. Digital signal processing operations may be performed on the input signal to achieve a desired result, such as an inverse noise signal for noise cancelation. However, operating on the input signal at the input sampling rate may incur additional energy costs (e.g., power draw), compared to operating at a reduced processing rate. Moreover, reduced sampling rates and/or reduced processing rates may incur increased latency (e.g., due to slower processing) and/or reduced resolution (e.g., audio fidelity), such as to accommodate the slower processing speed.

In some embodiments, to achieve a reduced processing rate, thus saving power, while maintaining or reducing latency and/or maintaining or increasing signal quality, filter circuitry may use sample rate conversion and modulation (e.g., via a sample rate conversion block and a noise shaped quantizer block of the filter circuitry) to reduce the sample rate of the input signal and utilize a warped FIR filter to process the modulated data (e.g., filter input). For example, the input signal, having an input sampling rate and input bit-depth, may be converted to an intermediate signal having a decreased sampling rate and an increased bit-depth. Additionally, the intermediate signal may be modulated, such as via noise shaped quantizer (e.g., delta-sigma modulator or sigma-delta modulator) with a multi-bit quantizer to generate a multi-bit (e.g., corresponding to the quantizer) filter input with a sampling rate (e.g., filter sampling rate) less than the input sampling rate. In some scenarios, the filter sampling rate may be the same as or greater than the intermediate sampling rate.

In some embodiments, the input signal (or intermediate signal) may be modulated, in accordance with an oversampling rate of the input signal for noise shaping. Indeed, such noise shaping may improve the signal-to-quantization-noise ratio (SQNR) in frequency bands of interest, such as the range typically sensitive to humans or otherwise as desired. Furthermore, in some embodiments, the noise shaped quantizer block of the filter circuitry may utilize a higher-order (e.g., higher than first order) modulation technique and/or higher-bit quantizer to perform noise shaping. For example, the input signal may be sampled at 3.072 MHz, converted to a lower sampling rate and modulated to a filter input with a 768 kHz sampling rate at 8-bits. As is presently recognized, in some scenarios, using sample-rate conversion and a higher-bit quantizer for modulation may effectively perform decimation with less latency than a typical decimation filter. As such, the fidelity of the input signal, particularly in a noise shaped frequency band of interest, may be maintained even while the input rate is decreased to a lower, filter sampling rate.

Further, in some embodiments, a warped FIR filter block of the filter circuitry may include a series of all-pass filter stages that provide phase shifts to a filter input (e.g., modulated signal) of the warped FIR filter block and a number of multipliers in parallel that operate to weight different phase responses of the filter input. By defining the coefficients of the multipliers and all-pass filters, the filter input may be modified to achieve a desired result, such as to generate a counteracting (e.g., inverse) audio signal corresponding to ambient noise represented by the input signal. In general, processing an 8-bit signal, or any signal with a bit-depth greater than one, may be more resource intensive (e.g., involve more circuitry or more complicated calculations) than processing a 1-bit signal. However, even if the processing circuitry may be more complicated per tap for higher bit-depths, by utilizing a warped FIR filter with all-pass filters for each filter stage, the number of tap points may be reduced, thus reducing the processing cost (e.g., circuitry footprint, computational complexity, power consumption) of the higher bit-depth signal (e.g., filter input). For example, a FIR filter may include a number of tap points for processing a digital conversion of the input signal at 1-bit. However, the warped FIR block may allow for a non-uniform frequency resolution that focuses on a frequency range of interest (e.g., similar to the modulation), which may utilize fewer tap points to maintain or improve the resolution in the frequency range of interest. Furthermore, in some embodiments, the series of all-pass filter stages may be disposed in a direct form or disposed in a transpose form. For example, the direct form may perform the multiplications on the phase shifted portions of the filter input, and the transpose form may perform the phase shifts of the all-pass filter stages on parallel portions of the filter input after the multiplications of the multipliers.

Additionally, in some embodiments, the coefficients of the warped FIR filter may be adaptive, such as to make corrections/changes to the effect of the warped FIR filter on the input signal based on the input signal and/or a feedback signal. For example, in the case of noise cancelation, while a first microphone receives ambient noise, a second microphone may be implemented at the output (e.g., speaker location) of the electronic device to receive a combined audio (e.g., feedback signal) including the ambient noise and the counteracting (e.g., inverse) audio. A dynamic adaptation block of the filter circuitry may determine an error associated with the phase, frequencies, and/or amplitudes of the counteracting audio and adjust the coefficients of the warped FIR filter based thereon to synchronize the ambient noise and the counteracting audio for improved cancelation. For example, the coefficient adjustments may account for speaker placement and/or orientation relative to an car of a user, atmospheric conditions (e.g., which may change the speed of sound), and/or differences in ambient noise amplitude and/or phase between the first microphone and the second microphone.

In some embodiments, the dynamic adaptation block may utilize reduced-rate (e.g., downsampled) versions of the input signal and/or feedback signal (e.g., adaptation signal(s)) to generate the filter coefficients. Moreover, in some embodiments, the dynamic adaption block may update the filter coefficients at a rate less than the processing rate (e.g., filter sampling rate) of the warped FIR filter block. For example, the input signal and/or feedback signal may be converted (e.g., via the sample-rate conversion block) to adaptation signal(s) having the intermediate sampling rate or a further reduced sampling rate, relative to the intermediate sampling rate. As such, filter circuitry, including a warped FIR filter, may be utilized for digital signal processing of an analog input signal with increased or maintained signal quality (e.g., in a frequency band of interest), decreased or maintained latency, and/or decreased energy consumption (e.g., power savings).

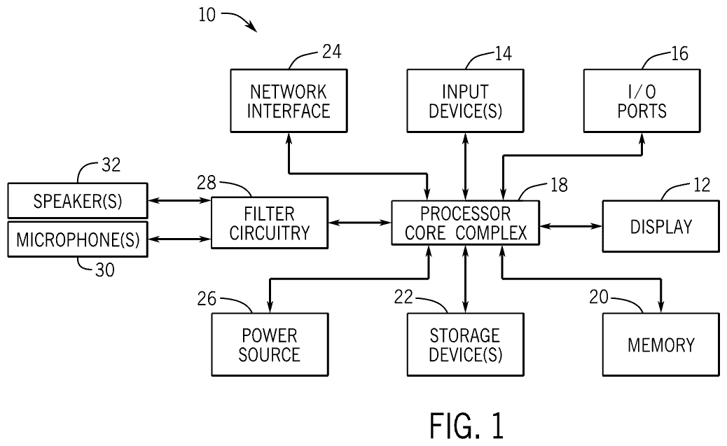

With the foregoing in mind, FIG. 1 is a block diagram of an electronic device 10 including an electronic display 12, that may utilize a warped FIR filter as discussed herein, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, earphones, a headset, or the like. Thus, it should be noted that FIG. 1 is merely one example of a particular implementation and is intended to illustrate the types of components that may be present in an electronic device 10.

The electronic device 10 may include an electronic display 12, one or more input devices 14, one or more input/output (I/O) ports 16, a processor core complex 18 having one or more processing circuits (circuitry) or processing circuitry cores, local memory 20, a main memory storage device 22, a network interface 24, a power source 26 (e.g., power supply), and/or filter circuitry 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component. Moreover, the filter circuitry 28 may be implemented as standalone circuitry and/or combined with or integral with the processor core complex 18.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 12. As such, the processor core complex 18 may include one or more processors, one or more general purpose microprocessors, one or more application specific integrated circuits (ASICs), one or more field programmable logic arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18 or the electronic display 12. For example, the power source 26 may include a power supply rail and/or a ground terminal coupled to the one or more components in the electronic device 10, such as the processor core complex 18 or the electronic display 12, to provide the electrical power. Thus, the power source 26 may include any suitable source of energy, such as a rechargeable lithium polymer (Li-poly) battery or an alternating current (AC) power converter.

The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12. Additionally, the input devices 14 may include one or more microphones 30 for receiving audio sounds. For example, a microphone 30 may convert audible sounds into electrical signals interpretable by the electronic device 10. Furthermore, speakers 32 may enable the electronic device 10 to convert electrical signals into audible sound. That is, the electronic device 10 may generate one or more audio signals and output the audio signal via the speakers 32. Thus, the speakers 32 may include components for amplifying and projecting sound to provide the audio output for various applications.

The electronic display 12 may display a graphical user interface (GUI) (e.g., of an operating system or computer program), an application interface, text, a still image, and/or video content. The electronic display 12 may include a display panel of any suitable type and include one or more display pixels to facilitate displaying images by controlling the luminance output (e.g., light emission) of the display pixels based on corresponding image data. Moreover, in some embodiments, the electronic device 10 may include multiple electronic displays 12 and/or may perform image processing for one or more external electronic displays 12, such as connected via the network interface 24 and/or the I/O ports 16.

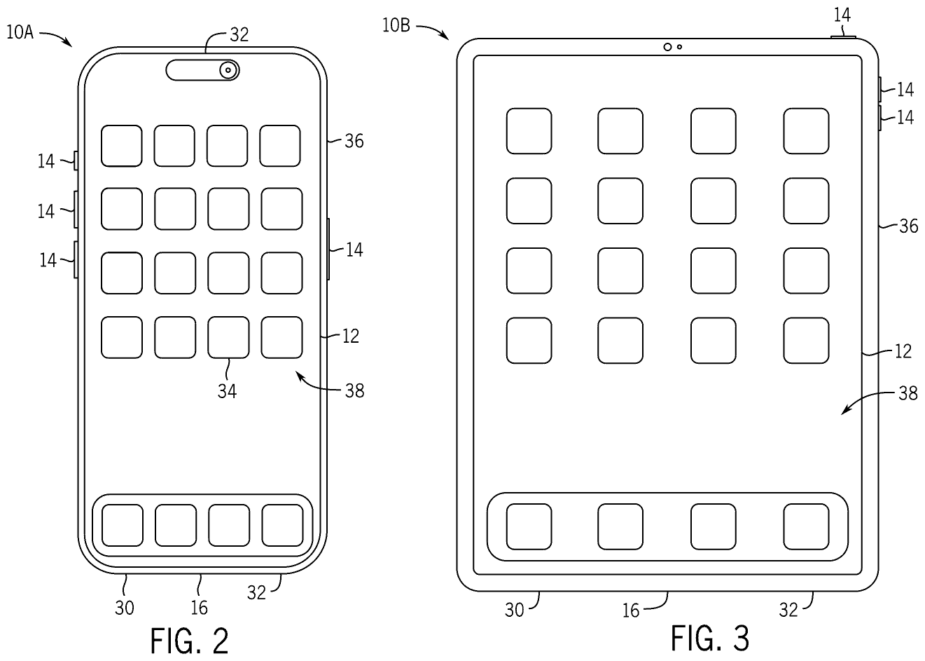

To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc. The handheld device 10A includes an enclosure 36 (e.g., housing). The enclosure 36 may protect interior components from physical damage or shield them from electromagnetic interference, such as by surrounding the electronic display 12, processor core complex 18, microphone(s) 30, and/or speaker(s) 32. The electronic display 12 may display a graphical user interface (GUI) 38 having an array of icons. As such, when an icon 34 is selected either by an input device 14 or a touch-sensing component of the electronic display 12, an application program may launch.

The input devices 14 may be accessed through openings in the enclosure 36. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature (e.g., via a microphone 30), provide volume control, or toggle between vibrate and ring modes.

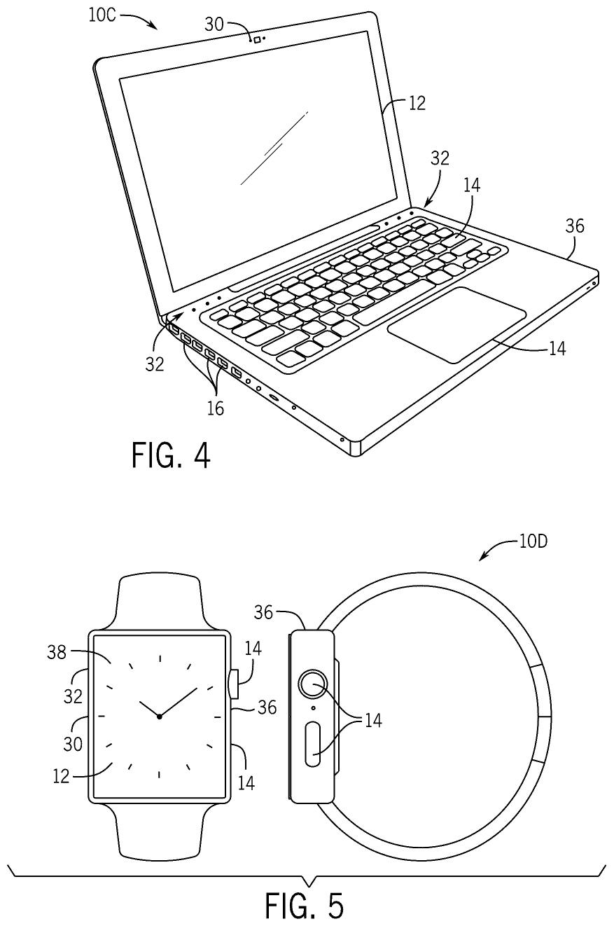

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Moreover, while the computer 10C is illustrated as a portable computer (e.g., notebook or laptop computer), the computer 10C may also be a desktop computer. Another example of a suitable electronic device 10, specifically a watch 10D, is shown in FIG. 5. For illustrative purposes, the watch 10D may be an APPLE WATCH® model available from Apple Inc.

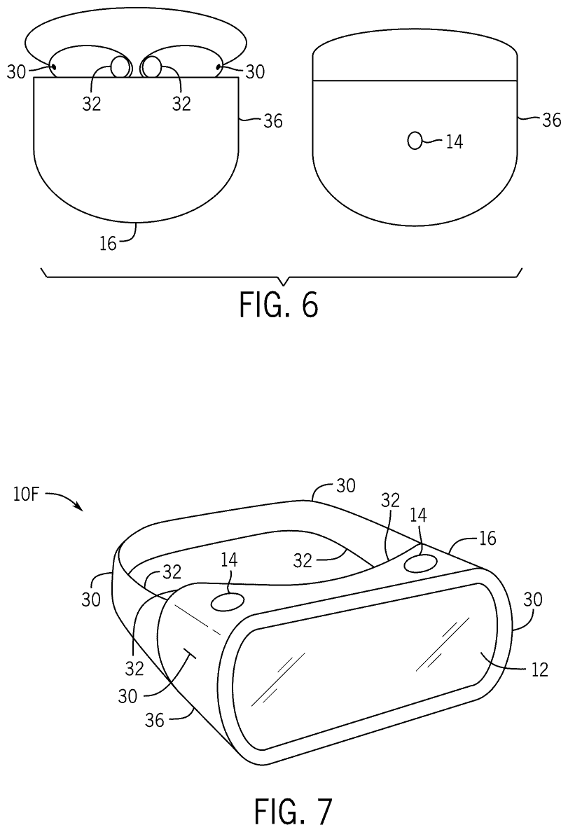

Another example of a suitable electronic device 10, specifically an audio device 10E, is shown in FIG. 6. For illustrative purposes, the audio device 10E may be any AIRPODS® model available from Apple Inc. Another example of a suitable electronic device 10, specifically a headset 10F (e.g., an extended reality (XR), mixed reality (MR), virtual reality (VR), and/or augmented reality (AR) headset), is shown in FIG. 7. For illustrative purposes, the headset 10F may be a VISION PRO® model available from Apple Inc.

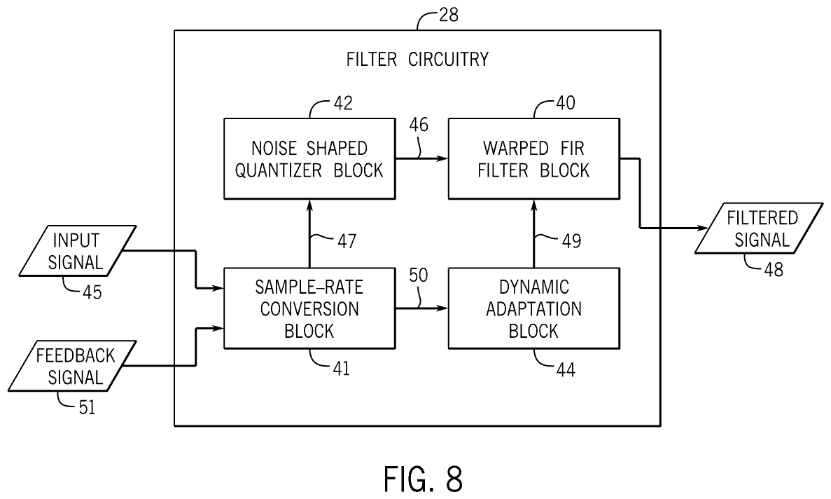

As discussed herein, the electronic device 10 may include one or more digital filters to augment digital data. For example, FIG. 8 is a block diagram of filter circuitry 28 including a warped FIR filter block 40, a sample-rate conversion block 41, a noise shaped quantizer block 42, and a dynamic adaptation block 44. As discussed further below, the sample-rate conversion block 41 and noise shaped quantizer block 42 may reduce the input sampling rate of and increase the bit-rate of an input signal 45 to that of a filter input 46, such as for use by the warped FIR filter block 40. For example, the sample-rate conversion block 41 may generate an intermediate signal 47 having an intermediate sampling rate less than the input sampling rate and a bit-depth greater than the input bit-depth. Additionally, the noise shaped quantizer block 42 may modulate the intermediate signal 47 (e.g., via a sigma-delta modulator or delta-sigma modulator) to generate the filter input 46. Furthermore, the warped FIR filter block 40 may generate a filtered signal (e.g., output of the filter circuitry 28) based on (e.g., by filtering) the filter input 46 based on a set of filter coefficients 49 that define the filter of the warped FIR filter block 40. Additionally, in some embodiments, the dynamic adaption block 44 may generate the set of filter coefficients 49 based on one or more adaptation signals 50, which may be or be based on the input signal 45 and/or a feedback signal 51. For example, in some embodiments, the adaption signal(s) 50 may include the intermediate signal 47 or a different rate-converted version of the input signal 45 (e.g., converted via one or more stages of the sample-rate conversion block 41). As should be appreciated, although the filter circuitry 28 is discussed herein as including a variety of blocks, embodiments may include hardware and/or software components to carry out the techniques discussed herein. Moreover, while the term “block” is used herein, there may or may not be a logical or physical separation therebetween. In general, the filter circuitry 28 may receive an input signal 45 and output a filtered signal 48. In some scenarios, the input signal 45 may be a continuous stream (e.g., over a period of time) of data, such as a microphone feed from one or more microphones 30 of electronic device 10, and the filtered signal 48 may be audio output, such as via one or more speakers 32 of the electronic device 10 or sent to a remote speaker 32, such as via the network interface 24 and/or I/O ports 16. As should be appreciated, while discussed herein in the context of an audio signal (e.g., input signal 45) the present techniques of the filter circuitry 28 may be applicable to other input signals 45, such as communication data signals and/or image data signals to name a few.

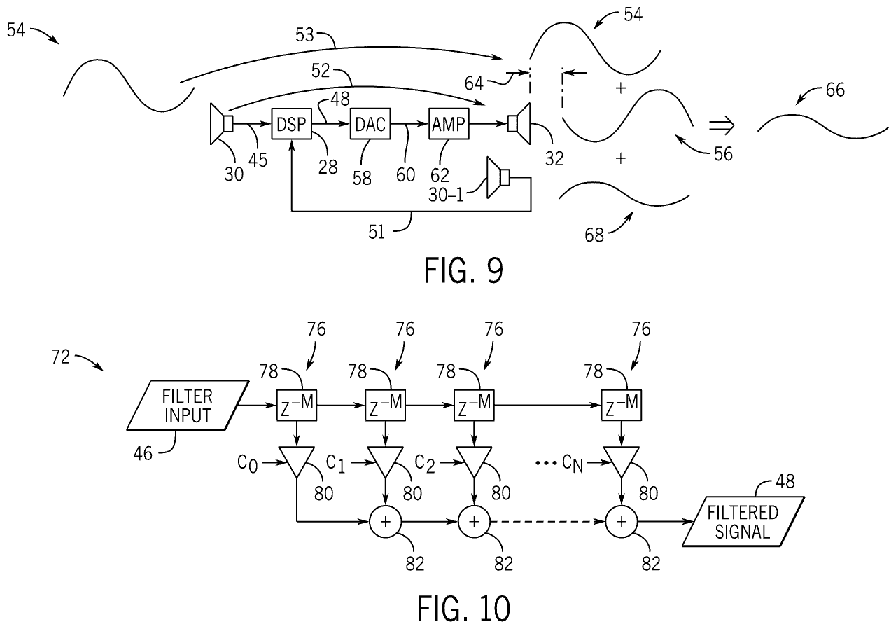

As discussed herein, it may be desirable to achieve input signal processing while conforming to one or more constraints, such as latency, signal quality, and computational costs (e.g., circuitry footprint, power consumption, and/or computational complexity). To help illustrate, FIG. 9 is a schematic diagram of a digital signal processing (DSP) path 52 of an electronic device 10 or system relative to an acoustic path 53 of an environmental audio sound 54. The electronic device 10 may perform noise canceling by receiving (e.g., via a microphone 30) the environmental audio sound 54, performing filtering (e.g., via the filter circuitry 28) of the environmental audio sound 54, and outputting (e.g., via a speaker 32) an inverted audio sound 56 that, when synchronized with the environmental audio sound 54 at a listening location (e.g., human car), renders the environmental audio sound 54 quieter or inaudible. For example, the microphone 30 may sample the environmental audio sound 54 at a sampling rate (e.g., 64 kHz, 128 kHz, 256 kHz, 512 kHz, 768 kHz, 1024 kHz, 1.536 MHz, 3.072 MHz, and so on) and bit-depth (e.g., 1-bit, 2-bit, 3-bit, 4-bit, and so on), and the input signal 45 may be generated based thereon. Moreover, after processing, the filtered signal 48 may be converted (e.g., via a digital-to-analog converter (DAC) 58) to an analog signal 60 and output via a speaker 32. The analog signal 60 may also be amplified, such as via an amplifier 62. As used herein, the input signal 45 may be a digital signal, such as converted via an analog-to-digital converter (ADC) within or separate from the microphone 30. Moreover, the filtered signal 48 may a digital signal, such as to be further processed and/or converted via a DAC 58. As should be appreciated, in some embodiments, the DAC 58 may be considered as incorporated into the filter circuitry 28 such that the filter circuitry 28 outputs the analog signal 60.

The timing of the DSP path 52 may be constrained and set to match the timing of the acoustic path 53 to reduce and/or minimize a phase difference 64 between the inverted audio sound 56 and the environmental audio sound 54. As such, the effective sound 66, such as heard at a listening location, may then be a combination of the inverted audio sound 56 and the environmental audio sound 54, with a smaller phase difference 64 providing for more accurate and effective noise cancelation. Furthermore, in some embodiments, the output sound of the speaker 32 may include the inverted audio sound 56 and a generated audio sound 68, such as a playback track, live audio feed, or other desired audible output of the electronic device 10. As should be appreciated, the generated audio sound 68 may be output from a different speaker 32 than the inverted audio sound 56 or the same speaker 32, for example where a generated signal, corresponding to the generated audio sound 68, is combined with the filtered signal 48 (e.g., in the digital domain) or combined with the analog signal 60 (e.g., in the analog domain).

Furthermore, to achieve a reduced phase difference 64, the DSP path 52 incurs a timing constraint (e.g., latency constraint) based on the acoustic path 53, which may vary based on the distance between the microphone 30 and the speaker 32, atmospheric conditions (e.g., air density, temperature, and/or humidity, which may affect acoustic speed), and/or physical objects along the acoustic path 53, such as a user's ear, which may reflect or otherwise alter the environmental audio sound 54 at the listening location (e.g., a user's ear) and, thus, the effective sound 66. In some embodiments, certain characteristics of the environment may be assumed or estimated, such as based on sensor feedback (e.g., accelerometers, barometric pressure sensors, and/or temperature sensors of the electronic device 10) or otherwise obtained information to estimate the acoustic path 53 and, thus proper timing. Additionally or alternatively, as discussed further below, in some embodiments, the electronic device 10 or system may include a second microphone 30-1 that monitors the effective sound 66 and provides a feedback signal 51 to the filter circuitry 28 (e.g., the dynamic adaptation block 44), such as for adjusting phase difference 64, amplitude difference, and/or the waveform difference between the inverted audio sound 56 and the environmental audio sound 54 (e.g., by changing one or more of the set of filter coefficients 49 and/or a controllable delay line) for improved cancelation.

While analog circuitry has traditionally been utilized in scenarios where latency is of considerable interest, analog circuitry may be particularly power intensive, have larger circuit footprints, and/or provide no or reduced dynamic feedback and/or variable programming. As such, it may be desirable to utilize DSP such as via a FIR filter for increased efficiency (e.g., decreased footprint and/or power consumption). In general, an input signal 45 (e.g., from a microphone 30) may be sampled at an input rate (e.g., sampling rate), such as via an ADC. For example, environmental audio sounds may be sampled via a microphone 30 at a sampling rate, such as 3 megahertz (MHz), at a bit-depth of 1-bit. DSP operations may be performed on a form of the input signal 45 (e.g., filter input 46) at the input rate or a converted rate, to achieve a desired result, such as the inverted audio sound 56 for noise cancelation.

For example, FIG. 10 is a schematic diagram of a FIR filter 72 receiving a filter input 46 (e.g., digital conversion of the input signal 45), processing the filter input 46 via multiple filter stages 76 (e.g., tap points), and outputting the filtered signal 48. In some embodiments, a filter stage 76 of the FIR filter 72 may include a phase delay 78 and a multiplier 80, and outputs of the filter stages 76 may be combined, such as via adders 82. In general, the phase delay 78 may be represented by a z-inverse function, Z^{-m}, where “m” is a number of sample delays. For example, a phase delay 78 of Z⁻⁴ in a filter stage 76 may represent a phase delay of four samples on the input to that filter stage 76. Additionally, each multiplier 80 may be associated with a coefficient, Cₙ. Together, the phase delays 78 and multiplications by the coefficients may modify the filter input 46 to achieve the filtered signal 48. However, while higher sampling rates, such as via a microphone 30 and/or ADC, may decrease the latency associated with sampling, operating (e.g., performing DSP) at the input sampling rate of the input signal 45, may incur additional energy costs (e.g., power draw), compared to operating at a reduced processing rate. As such, it may be desirable to reduce the operating rate of the filter circuitry 28 while maintaining a higher input sampling rate. For example, the input signal 45 may be decimated to reduce the sampling rate while increasing the bit-depth. However, in some scenarios, typical decimation filters may introduce unacceptable amounts of latency.

Indeed, in the case of audio, the audio frequency range to which humans are typically sensitive ranges from 0 to about 20 kilohertz (kHz), and historical audio data rates include 16 kHz, 24 kHz, 32 kHz, and 48 kHz to represent audio data in this range. Additionally, audio data may be oversampled (e.g., via a microphone 30), such as at 768 kHz, 1.536 MHz, 3.072 MHz, or other sampling rate depending on implementation. For example, the sampling rate may be 3.072 MHz which, oversamples a 48 KHz data rate by a factor of 64 and oversamples a 768 kHz processing rate by a factor of 16. As should be appreciated, an audio sample may be oversampled by any suitable factor such as 2, 4, 8, 16, 32, 64, and so on, depending on implementation. In some embodiments, the input signal 45 may be modulated (e.g., via the noise shaped quantizer block 42), such as for noise shaping, in accordance with an oversampling ratio (e.g., factor) of the input signal 45. Indeed, such noise shaping may improve the signal-to-quantization-noise ratio (SQNR) in frequency bands of interest, such as the range typically sensitive to humans or otherwise as desired. For example, noise shaping may push noise artifacts (e.g., quantization noise) in the sampled signal to a higher frequency range such that the noise artifacts are in an inaudible frequency range for humans. Moreover, the SQNR may be a function of the oversampling ratio, and higher oversampling ratios may provide improved quality. As such, it may be desirable to maintain a higher oversampling ratio while decreasing the processing rate.

To achieve the higher and/or maintained oversampling ratio while decreasing the processing rate, the sample-rate conversion block 41 and noise shaped quantizer block 42 may convert the input signal 45 to an intermediate signal 47 at a sample rate less than the input sample rate and higher bit-depth and modulate the intermediate signal 47 (e.g., via a delta-sigma modulator or sigma-delta modulator), respectively, to generate the filter input 46 at a lower sample rate than the input sample rate. As should be appreciated, the sample-rate conversion block 41 may include one or more stages for reducing the sampling rate of the input signal 45. For example, the sample-rate conversion block 41 may resample to input signal 45 to a secondary and/or tertiary intermediate sampling rate before achieving the intermediate sampling rate of the intermediate signal 47. Additionally, in some embodiments, the filter input 46 may have a bit-depth greater than the input bit-depth. For example, the noise shaped quantizer block 42 may modulate the intermediate signal 47 with a quantizer greater than one bit (e.g., 2-bit quantizer, 3-bit quantizer, 4-bit quantizer, 5-bit quantizer, 6-bit quantizer, 7-bit quantizer, 8-bit quantizer, and so on). Indeed, using a quantizer greater than one bit may provide improved SQNR while maintaining or with a reduced oversampling ratio. For example, for a data rate of 48 KHz and a sampling rate of 3.072 MHz, the input signal 45 may be oversampled by a factor of 64. However, if the processing rate (e.g., filter sampling rate) is reduced (e.g., via the sample-rate conversion block 41 and/or noise shaped quantizer block 42) to 768 kHz, the oversampling ratio may be reduced to 16, which may not achieve the desired signal quality (e.g., SQNR) using a 1-bit quantizer for modulation. However, by utilizing a higher-bit quantizer (e.g., 8-bit) to generate an 8-bit, 768 kHz modulated signal, the filter input 46 may be of an improved and/or maintained signal quality, as compared to the input signal 45 quantized at 1-bit, while achieving a reduced filter sampling rate. Additionally, in some embodiments, the noise shaped quantizer block 42 of the filter circuitry 28 may utilize a higher order (e.g., higher than first order) modulation technique (e.g., second order, third order, fourth order, fifth order, sixth order, seventh order, eighth order, and so on), such as for improved SQNR, along with a higher-bit quantizer to perform noise shaping. As such, the fidelity of the input signal 45, particularly in a noise shaped frequency band of interest, may be maintained while the processing rate is decreased to a lower, thus saving power.

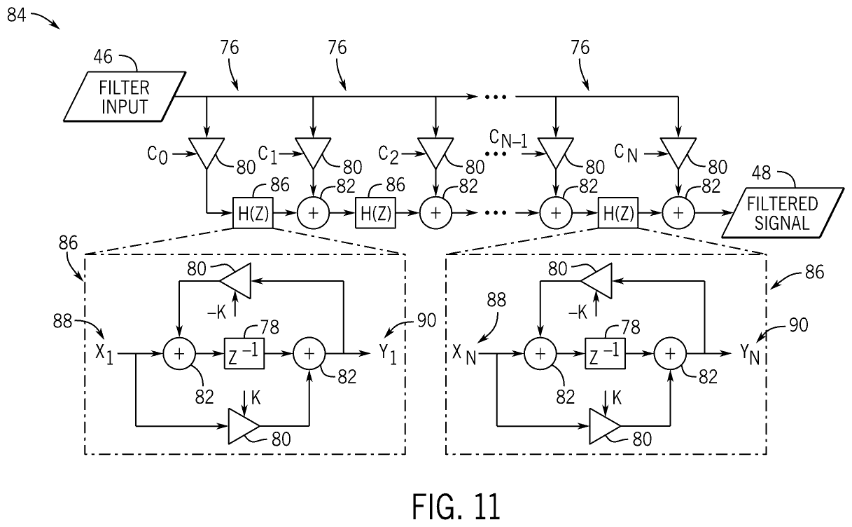

In addition to utilizing the filter input 46 generated via the sample-rate conversion block 41 and noise shaped quantizer block 42, in some embodiments the filter circuitry 28 may utilize the warped FIR filter block 40 to generate the filtered signal 48 (e.g., as opposed to the FIR filter 72). To help illustrate, FIG. 11 is a schematic diagram of a portion (e.g., warped FIR filter block 40) of the filter circuitry 28 including a warped FIR filter 84 having a filter input 46 (e.g., digital conversion of the input signal 45 or modulated digital conversion of the input signal 45), multiple filter stages 76, and the filtered signal 48 as the output. As with the FIR filter 72, the warped FIR filter 84 may include multiple filter stages 76 having multipliers 80 with corresponding coefficients, Cn, and adders 82 summing the filter stages 76. In some embodiments, the warped FIR filter 84 may include a series of all-pass filters 86 that provide augmented phase shifts to the respective all-pass inputs 88 (e.g., a transitional signal of the warped FIR filter 84). Moreover, the respective all-pass outputs 90 may be added (e.g., via adders 82) in series to the outputs of the multipliers 80 that are in parallel generate the filtered signal 48. As should be appreciated, the all-pass filters 86 may include one or more multipliers 80, with coefficients K and −K and one or more adders 82 to define resolution shaping about a frequency range of interest, such as the audible frequency range. For example, while the all-pass filters 86 may allow all frequencies therethrough, lower frequencies may encounter higher delay providing additional fidelity in the lower frequencies. Moreover, while the higher frequencies may have reduced resolution (e.g., in favor of the lower frequencies), in some scenarios, the frequency band of lower resolution may be of little or no consequence. For example, such decreased resolution may be in inaudible frequency ranges, similar to noise shaping of the noise shaped quantizer block 42. As should be appreciated, the values of the higher and lower frequencies for increased resolution via the all-pass filters 86 may depend on implementation, such as based on values of K and/or Cn. For example, the coefficients, Cn and K, may be set such that the all-pass filters 86 improve resolution at frequencies below 10 kHz, below 20 kHz, below 50 kHz, and so on.

Additionally, in some embodiments, the values of K may be limited to a set of discrete values for improved processing efficiency. For example, the multipliers 80 within the all-pass filters 86 may be implemented as a shift-and-adds instead of a processing a full multiplication. Moreover, in some embodiments, the processing of the warped FIR filter 84 may be performed in fixed point instead of floating point for increased efficiency. For example, floating point may allow for a wider dynamic range of computations than expected to occur within the warped FIR filter 84. As such, fixed point memory and computations may be utilized for reduced computational complexity and reduced power consumption.

By defining the coefficients of the multipliers 80, Cn and K, the filter input 46 may be modified to achieve a desired result, such as to generate an inverted audio sound 56 corresponding to the environmental audio sound 54 represented by the input signal 45. As discussed above, the warped FIR filter 84 may operate at a bit-depth greater than one, as the filter input 46 may be produced by modulating (e.g., via the noise shaped quantizer block 42) with a quantizer greater than one bit. In general, processing a higher bit signal may be more resource intensive (e.g., involve more circuitry or more complicated calculations) than processing a 1-bit signal. However, even if the processing/circuitry may incur increased complexity per filter stage 76 at higher bit-depths, by utilizing the warped FIR filter 84 with all-pass filters 86, the number of filter stages 76 (e.g., tap points) may be reduced (e.g., compared to the FIR filter 72), thus reducing the processing cost (e.g., circuitry footprint, computational complexity, computational time, and/or power consumption). For example, as discussed above, the all-pass filters 86 may provide increased resolution at frequencies of interest. As such, the same or improved resolution in the frequencies of interest may be realized with fewer filter stages 76. In other words, the warped FIR filter block 40 may allow for a non-uniform frequency resolution that focuses on a frequency range of interest, which may utilize fewer filter stages 76 (e.g., tap points) while maintaining or improving the resolution in the frequency range of interest.

Returning briefly to FIG. 10, the FIR filter 72 is disposed in a direct form. Conversely, the warped FIR filter 84 of FIG. 11 is disposed in a transpose form. However, as should be appreciated, the warped FIR filter 84 may also be disposed in the direct form. Furthermore, in some embodiments, the transpose form may provide efficiency and/or quality improvements over the direct form. For example, the direct form may perform multiplications (e.g., via the multipliers 80) after the all-pass filters 86, and the transpose form may perform the multiplications (e.g., via the multipliers 80) after the all-pass filters 86. However, the all-pass filters 86 may have higher bit outputs than the filter input 46. As such, the transpose form may improve efficiency by reducing the computational complexity of the multipliers 80 to the bit-depth of the filter input 46, as opposed to the relatively increased bit-depth of the all-pass filter outputs. Furthermore, the transpose form may provide for smoothed transients, relative to the direct form, with respect to coefficient changes (e.g., changes in Cn), which may be adjusted by the dynamic adaptation block 44.

As discussed herein, in some embodiments, the coefficients (e.g., Cn and/or K) of the warped FIR filter 84 (e.g., of the warped FIR filter block 40) may be adaptive, such as to make corrections/changes to the effect of the warped FIR filter 84 on the input signal 45. Returning to FIG. 9, in the case of noise cancelation, while a first microphone 30 receives the environmental audio sound 54, a second microphone 30-1 may be implemented at an output location (e.g., location of the speaker 32) to receive a combined audio (e.g., the effective sound 66) including the environmental audio sound 54 and the inverted audio sound 56. The second microphone 30-1 may send the feedback signal 51 associated with the effective sound 66, which may include residual noise from the environmental audio sound 54 that was not adequately canceled and provide the feedback signal 51 to the dynamic adaptation block 44 (e.g., as an adaptation signal 50). The dynamic adaptation block 44 may determine an error associated with the phase, frequencies, and/or amplitudes of the inverted audio sound 56 and adjust the set of coefficients 49 (e.g., Cn and/or K) of the warped FIR filter 84 based thereon to synchronize with and counteract the environmental audio sound 54 with the inverted audio sound 56 for improved cancelation. For example, the coefficient adjustments may account for speaker placement and/or orientation relative to an car of a user, a seal of the speaker 32 within or around the car, atmospheric conditions (e.g., which may change the speed of sound), and/or other variations in the environmental audio sound 54 amplitude, frequency, and/or phase between the first microphone and the second microphone.

In some embodiments, the adaptation signals 50 received by the dynamic adaptation block 44 may be reduced-rate (e.g., downsampled) versions of the input signal 45 and/or feedback signal 51. Moreover, in some embodiments, the dynamic adaption block 44 may update the set of filter coefficients 49 at a rate less than the processing rate (e.g., filter sampling rate) of the warped FIR filter block. For example, the input signal 45 and/or feedback signal 51 may be converted (e.g., via the sample-rate conversion block 41) to adaptation signal(s) having the intermediate sampling rate or a further reduced sampling rate, relative to the intermediate sampling rate. Furthermore, in some embodiments, the sample-rate conversion block 41 may reduce the sampling rate of the input signal 45 and/or feedback signal 51 in a single stage or multiple stages. For example, the sample-rate conversion block 41 may include a first sample-rate conversion stage reducing the input sampling rate of the input signal 45 to the intermediate sampling rate (e.g., for use by the noise shaped quantizer block 42) and a second sample-rate conversion stage reducing the intermediate sampling rate to an adaptation sampling rate of the adaptation signal(s) 50. As such, the filter circuitry 28, including a warped FIR filter 84, may be utilized for digital signal processing of an input signal 45 with increased or maintained signal quality (e.g., in a frequency band of interest), decreased or maintained latency, and/or decreased energy consumption (e.g., power savings).

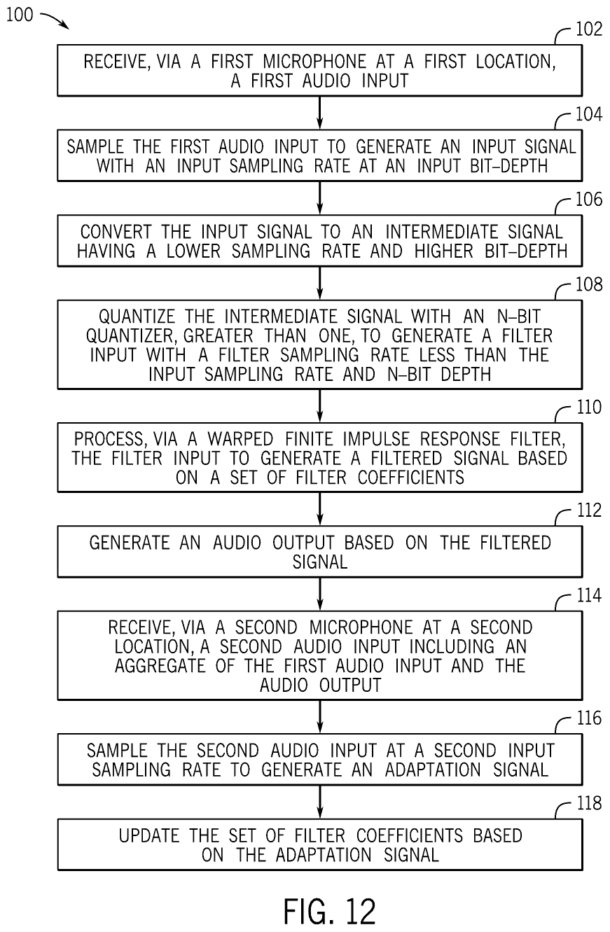

FIG. 12 is a flowchart of an example process 100 for implementing filter circuitry 28 to generate a dynamically adaptive audio output based on a received audio input. As should be appreciated, while discussed in the context of audio signals, the process 100 may be implemented for any suitable input signal desired for filtering and generating an output signal based thereon. In some embodiments, an electronic device 10 may receive, via a first microphone 30, a first audio input (process block 102), which may be sampled to generate an input signal having an input sampling rate and input bit-depth (process block 104). In some scenarios, the input sampling rate may be oversampled by a factor relative to a data rate of the audio input. As should be appreciated, the data rate and/or oversampling rate may be based on implementation. The filter circuitry 28 may also convert (e.g., via the sample-rate conversion block 41) the input signal 45 into an intermediate signal 47 having a lower sampling rate and higher bit-depth, relative to the input signal 45 (process block 106). Additionally, the filter circuitry 28 may quantize (e.g., via the noise shaped quantizer block 42) the input signal 45 with an n-bit quantizer (e.g., greater than one) to generate a filter input 46 with a sampling rate less than the input sampling rate and n-bit depth (process block 108). As should be appreciated, the filter input 46 may have a bit-depth less than or equal to the higher bit-depth of the intermediate signal 47. Additionally, the filter input 46 may be processed, via a warped FIR filter 84, to generate a filtered signal 48 based on a set of filter coefficients 49 (process block 110). For example, the warped FIR filter 84 may utilize a series of filter stages 76 having all-pass filters 86 and multipliers 80 with respective coefficients (e.g., Cn and/or K). Further, an audio output may be generated (e.g., via a DAC 58 and/or speaker 32) based on the filtered signal 48 (process block 112). As such, the filter circuitry 28 may produce an audio output based on filtering of a received audio input. Furthermore, a second audio input (e.g., effective sound 66) including an aggregate of the first audio input (e.g., environmental audio sound 54) and audio output (e.g., inverted audio sound 56) may be received via a second microphone (e.g., microphone 30-1) at a second location (e.g., proximate the speaker 32) (process block 114). For example, the second microphone 30-1 may capture a residual noise from the environmental audio sound 54 that was not canceled by the inverted audio sound 56 and provide a feedback signal 51 to the dynamic adaptation block 44. The second audio input may be sampled (and/or resampled, such as via the sample-rate conversion block 41) at a second input sampling rate to generate an adaptation signal 50 (process block 116). Moreover, the set of filter coefficients 49 may be updated based on the adaptation signal 50 (process block 118) and/or a second adaptations signal 50, such as converted from the input signal 45. For example, the respective coefficients (e.g., Cn and/or K) of the multipliers 80 and all-pass filters 86 of the warped FIR filter 84 may be altered, based on the feedback signal 51, to improve the desired audio output.

As such, in accordance with aspects of the present disclosure, a warped FIR filter 84 may be utilized to implement an improved filter architecture that maintains a filtering quality for a given time constraint (e.g., latency) with reduced power consumption. As should be appreciated, while certain sampling rates, processing rates, and/or other data rates, as well as modulations thereof, are discussed herein as examples, as should be appreciated, different rates and modulations may be utilized with the techniques discussed herein depending on implementation. Furthermore, although the flowchart discussed above is shown in a given order, in certain embodiments, process blocks may be reordered, altered, deleted, and/or occur simultaneously. Additionally, the flowchart is given as an illustrative tool and further decision and process blocks may also be added depending on implementation.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. An electronic device comprising:
a microphone configured to receive a first acoustic sound and generate a first input signal based on the first acoustic sound;
filter circuitry comprising a plurality of filter stages, wherein each filter stage of the plurality of filter stages comprises an all-pass filter and a multiplier, and wherein the filter circuitry is configured to:
determine a filter input based on the first input signal; and
process the filter input via the plurality of filter stages to generate a filtered signal; and
a speaker configured to output a second acoustic sound based on the filtered signal.

2. The electronic device of claim 1, wherein the plurality of filter stages is configured to process the filter input based on operations comprising:
multiplying, via the multiplier of a first filter stage of the plurality of filter stages, the filter input by a respective coefficient of the multiplier of the first filter stage to generate a first transitional signal;
adding the first transitional signal to a first all-pass output of the all-pass filter of a second filter stage of the plurality of filter stages to generate a second transitional signal; and
applying the all-pass filter of the first filter stage to the second transitional signal to generate a second all-pass output signal.

3. The electronic device of claim 1, comprising an error microphone configured to receive a mixed acoustic sound comprising the first acoustic sound and the second acoustic sound, wherein the filter circuitry is configured to adjust a respective coefficient of the multiplier of one or more filter stages of the plurality of filter stages based on the mixed acoustic sound, adjust a respective all-pass coefficient of the all-pass filter of the filter stage based on the mixed acoustic sound, or both.

4. The electronic device of claim 1, wherein the filter circuitry is configured to generate the filter input based on:
converting the first input signal from a first sampling rate to a second sampling rate less than the first sampling rate to generate an intermediate signal; and
modulating the intermediate signal to generate the filter input, wherein the filter input comprises a third sampling rate less than the first sampling rate.

5. The electronic device of claim 4, wherein the filter circuitry comprises a delta sigma modulator or a sigma delta modulator, wherein the delta sigma modulator or the sigma delta modulator is configured to modulate the intermediate signal with an n-bit quantizer greater than one, and wherein the filter input comprises an n-bit depth.

6. The electronic device of claim 1, wherein the first acoustic sound is at a first location of the microphone at a first time and has traveled to a second location of the speaker at a second time, wherein the microphone is configured to receive the first acoustic sound at the first time, and wherein the speaker is configured to output the second acoustic sound at the second time.

7. The electronic device of claim 1, wherein the second acoustic sound is based on a mixed audio signal comprising at least a portion of the filtered signal and at least a portion of another audio signal.

8. The electronic device of claim 7, wherein the other audio signal comprises a pre-recorded audio track, a generated audio track distinct from the first input signal, or a combination thereof.

9. The electronic device of claim 1, wherein the filter circuitry is configured to process the filter input in fixed point.

10. The electronic device of claim 1, wherein the filter circuitry is configured to perform a multiplication for the multiplier of each filter stage of the plurality of filter stages via a shift-and-add operation.

11. Filter circuitry configured to:
receive an input signal at a first sampling rate and a first bit-depth;
convert the first sampling rate and the first bit-depth of the input signal to a second sampling rate less than the first sampling rate and a second bit-depth greater than the first bit-depth to generate an intermediate signal;
modulate the intermediate signal to generate a filter input signal comprising a processing rate less than the first sampling rate;
filter, via a warped finite impulse response filter, the filter input signal based on a set of filter coefficients to generate a filtered signal; and
output the filtered signal.

12. The filter circuitry of claim 11, wherein the filter circuitry comprises a delta sigma modulator or a sigma delta modulator, the delta sigma modulator or the sigma delta modulator configured to modulate the intermediate signal with a quantizer greater than one bit to noise shape the intermediate signal, wherein quantization noise is shifted away from a first frequency range and to a second frequency range higher than the first frequency range.

13. The filter circuitry of claim 12, wherein the delta sigma modulator or the sigma delta modulator comprises a modulation order greater than one.

14. The filter circuitry of claim 11, wherein modulating the intermediate signal comprises change from the second bit-depth to a third-bit depth, of the filter input signal, less than the second bit-depth.

15. The filter circuitry of claim 11, wherein the input signal is indicative of an environment audio sound and the filtered signal is indicative of an inverted audio sound, wherein the filter circuitry is configured to:
receive a feedback signal indicative of residual sound comprising a summation of the environment audio sound and the inverted audio sound; and
adjust one or more coefficients of the set of filter coefficients based on the feedback signal.

16. The filter circuitry of claim 11, wherein the warped finite impulse response filter comprises a plurality of all-pass filter stages disposed in a transpose form.

17. A non-transitory, machine-readable medium comprising instructions, wherein, when executed by one or more processors, the instructions cause the one or more processors to control operations of filter circuitry or to perform the operations, the operations comprising:
receiving an input signal at a first sampling rate;
resampling the input signal to generate an intermediate signal at a second sampling rate less than the first sampling rate;
modulating the intermediate signal to generate a filter input signal comprising a processing rate less than the first sampling rate;
filtering, via a warped finite impulse response filter and at the processing rate, the filter input signal based on a set of filter coefficients to generate a filtered signal; and
outputting the filtered signal.

18. The non-transitory, machine-readable medium of claim 17, wherein the input signal comprises a first bit-depth and the filter input signal comprises a second bit-depth greater than the first bit-depth.

19. The non-transitory, machine-readable medium of claim 17, wherein modulating the intermediate signal comprises noise shape quantizing the intermediate signal via an n-bit quantizer greater than one.

20. The non-transitory, machine-readable medium of claim 17, wherein filtering the filter input signal comprises:
multiplying the filter input signal by a multiplier coefficient of the set of filter coefficients to generate a first transitional signal of a first filter stage of the warped finite impulse response filter;
adding the first transitional signal to a first all-pass output of a second filter stage of the warped finite impulse response filter to generate a second transitional signal; and
applying an all-pass filter of the first filter stage to the second transitional signal to generate a second all-pass output signal.
